(19) United States
(12) Patent Application Publication
(10) Pub. No.: US 2016/0055294 A1
(43) Pub. Date: Feb. 25, 2016

(54) METHOD AND APPARATUS FOR DETERMINING TRANSCRIPTION FACTOR FOR BIOLOGICAL PROCESS

(71) Applicant: SAMSUNG ELECTRONICS CO., LTD., Suwon-si (KR)

(72) Inventors: Misook HA, Hwaseong-si (KR); Sungjin KIM, Suwon-si (KR)

(73) Assignee: SAMSUNG ELECTRONICS CO., LTD., Suwon-si (KR)

(21) Appl. No.: 14/615,182

(22) Filed: Feb. 5, 2015

(30) Foreign Application Priority Data
Aug. 21, 2014 (KR) 10-2014-0109003

(51) Int. Cl. G06F 19/20; G06F 19/22

(52) U.S. Cl. CPC G06F 19/20; G06F 19/22

(57) ABSTRACT

A method and an apparatus for determining a transcription factor for a biological process are provided. The method of determining a transcription factor involves obtaining N items of expression data related to gene information, selecting M items of expression data based on similarities of the N items of expression data, and forming the selected M items of expression data as a first group using a processor, comparing the expression data of the first group to expression data of a plurality of transcription factors, and identifying at least one transcription factor having a relatively high similarity to the first group, among the transcription factors, in which M is a natural number less than or equal to N.

### CROSS-REFERENCE TO RELATED APPLICATIONS

This application claims the benefit under 35 USC 119(a) of Korean Patent Application No. 10-2014-0109003 filed on Aug. 21, 2014, in the Korean Intellectual Property Office, the entire disclosure of which is incorporated herein by reference for all purposes.

### BACKGROUND

1. Field

The following description relates to a method and an apparatus for determining a transcription factor related to a biological process.

2. Description of Related Art

With the decoding of the human genome sequence through the human genome project and with the development of information technology, there is growing interest in functional genomics such as, for example, bioinformatics and research and analysis regarding the functions of genes. A technique that has greatly spurred the development of functional genomics is the use of deoxyribonucleic acid (DNA) chips, also known as DNA microarrays, which increased the efficiencies of performing large scale experiments. Through such experiments, an experiment and analysis on a set of genes performing biologically the same function and purpose may be performed in a short amount of time, but the experiments do not directly result in a prediction of a function of an individual gene unit. However, since thousands or tens of thousands of bases constitute a single gene, an astronomically enormous amount of data needs to be processed in order to determine a gene or a portion of the gene that is abnormal or causes a genetic disease, among the approximately one hundred thousand human genes in the human genome. Accordingly, there is a demand for developing techniques of information technology that processes the data. For example, the establishment of a gene prediction program and a database may be beneficial, so that a large amount of gene base sequence data and information on functions thereof revealed from many experiments may be analyzed by utilizing computers and software, and the functions of genes may be reconstructed and applied to medicine.

With the development of genomics, research on gene expression regulation is being actively conducted. The gene expression regulation may be a main method by which the body regulates origination of a normal entity and development of a tissue, and also a main method by which the body regulates a response with respect to an external stimulus such as to an environmental change. When gene expression regulation is abnormally performed, serious diseases such as teratogenesis, transformation to a tumor cell, immune deficiency, and loss of homeostasis by a biological hormone, may result.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, there is provided a method of determining a transcription factor, the method involving obtaining N items of expression data related to gene information, selecting M items of expression data based on similarities of the N items of expression data, and forming the selected M items of expression data as a first group using a processor, comparing the expression data of the first group to expression data of a plurality of transcription factors, and identifying at least one transcription factor having a relatively high similarity to the first group, among the transcription factors, in which M is a natural number less than or equal to N.

The N items of expression data related to the gene information may be obtained from a second database storing expression data related to the gene information.

The N items of expression data related to the gene information may be obtained through hybridization of probes and biological samples containing at least one of deoxyribonucleic acids (DNAs) having the gene information and proteins expressed from the DNAs.

The selecting may include generating a gene network among the N items of expression data, and selecting the M items of expression data from among the N items of expression data using the gene network.

The selecting of the M items of expression data from among the N items of expression data using the gene network may involve selecting the M items of expression data having gene-gene interactions (GGIs) greater than or equal to a preset threshold in the gene network.

The selecting may involve calculating GGIs among the N items of expression data, and selecting the M items of expression data from among the N items of expression data based on the calculated GGIs among the N items of expression data.

Each level of expression of the M items of expression data may be regulated depending on different expression conditions.

The general aspect of the method may further involve extracting the gene information associated with a biological process from a first database.

The first database may be configured to store the gene information associated with the biological process, and output gene information corresponding to an input biological process.

In another general aspect, there is provided a method of determining a transcription factor, the method involving obtaining N items of expression data related to gene information from a database comprising a memory, forming a first group of expression data based on similarities of the N items of expression data, and comparing a pattern of the expression data of the first group to respective patterns of expression data of a plurality of transcription factors.

The general aspect of the method may further involve identifying at least one transcription factor having a relatively high similarity to the first group, among the transcription factors.

The forming may involve forming the first group of expression data by selecting M items of expression data from among the N items of expression data using a gene network among the N items of expression data.

The forming of the first group of expression data by selecting the M items of expression data may involve selecting the M items of expression data having gene-gene interactions (GGIs) greater than or equal to a preset threshold in the gene network.

In another general aspect, there is provided a non-transitory computer storage medium storing instructions that causes a computer to perform the method described above.

In yet another general aspect, there is provided an apparatus for determining a transcription factor, the apparatus including a database configured to store N items of expression data related to gene information, and a processor configured to read out the N items of expression data related to the gene information from the database, form M items of expression data selected based on similarities of the N items of expression data as a first group, and compare the expression data of the first group to expression data of a plurality of transcription factors, in which M is a natural number less than equal to N.

The processor may be configured to select the M items of expression data from among the N items of expression data using a gene network among the N items of expression data.

The processor may be configured to obtain a first pattern from the expression data of the first group, and compare the expression data of the first group to the expression data of the plurality of transcription factors by comparing the first pattern to respective patterns of the plurality of transcription factors.

In another general aspect, there is provided an apparatus for determining a transcription factor related to a biological process, the apparatus including an input device configured to receive an input regarding a biological process, a gene information processor configured to obtain gene information related to the biological process from a first database and store N items of expression data related to the gene information in a memory, and an expression data processor configured to process the N items of expression data and determine M items of expression data selected based on similarities of the N items of expression data as a first group, and compare the expression data of the first group to expression data of a plurality of transcription factors, in which M is a natural number less than equal to N.

The expression data processor may be configured to select the M items of expression data from among the N items of expression data using a gene network among the N items of expression data.

The general aspect of the apparatus may further include a microarray processor configured to obtain the expression data of the plurality of transcription factors by analyzing data obtained from one or more microarrays.

Other features and aspects will be apparent from the following detailed description, the drawings, and the claims.

### BRIEF DESCRIPTION OF THE DRAWINGS

FIG. 1 is a flowchart illustrating an example of a method of determining a transcription factor for a biological process.

FIG. 2 is a flowchart illustrating an example of an operation of selecting M items of expression data based on similarities of N items of expression data.

FIG. 3 is a flowchart illustrating another example of an operation of selecting M items of expression data based on similarities of N items of expression data.

FIG. 4 is a flowchart illustrating another example of a method of determining a transcription factor for a biological process.

FIG. 5 is a block diagram illustrating an example of an apparatus for determining a transcription factor for a biological process from a database.

FIG. 6 is a diagram illustrating an example of an intercellular gene expression regulation mechanism.

FIG. 7 illustrates an example of a diagram illustrating a gene network of genes related to a deoxyribonucleic acid (DNA) repair process.

FIG. 8 illustrates examples of expression data of transcription factors and expression data of genes related to a DNA repair process.

FIG. 9 is a block diagram illustrating another example of an apparatus for determining a transcription factor for a biological process.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

With the development of genomics, there exists a demand for developing techniques of information technology that processes the large amount of data that are being collected. The gene expression regulation may be a main method by which the body regulates origination of a normal entity and development of a tissue, and also a main method by which the body regulates a response with respect to an external stimulus such as an environmental change. Thus, artificial gene expression regulation technologies may be used to treat diseases. Among these technologies, technology that utilizes a transcription factor acting in a transcription process that is an early stage of gene expression may be useful.

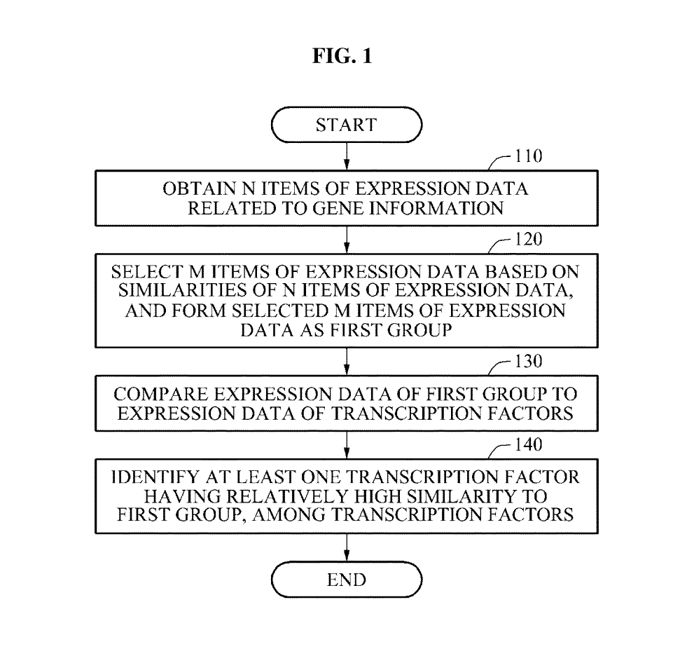

FIG. 1 is a flowchart illustrating an example of a method of determining a transcription factor for a biological process.

Referring to FIG. 1, in operation 110, the method of determining a transcription factor for a biological process of interest involves obtaining N items of expression data related to gene information.

The gene information may include all information associated with genes. For example, the gene information may include information regarding proteins generated from a gene, genes that code the proteins, regulatory genes for the protein, regulatory proteins, sequence information of deoxyribonucleic acids (DNAs), messenger ribonucleic acids (mRNAs) related with the protein or the gene, complementary deoxyribonucleic acids (cDNAs) related with the protein or the gene, or amino acids of such genes and proteins, biological processes associated with such genes or proteins, and information about cells or tissues in which such genes or proteins are expressed. In one example, the gene information may refer to gene information associated with a predetermined biological process, or information about proteins or genes known as being related to a predetermined biological process.

Biological processes may include an intercellular process, a cell-to-cell process, and an extracellular process, but are not limited thereto. In an example, the biological processes may include DNA repair, glucolysis, insulin production, amino acid synthesis, cytokine synthesis and secretion, hormone production and secretion, adenosine triphosphate (ATP) production, cell division, apoptosis, and tumor cell generation. The biological processes are performed by actions of proteins. Gene expression of a protein group performing a predetermined biological process may be regulated by a regulator or a transcription factor that regulates expression of a predetermined gene.

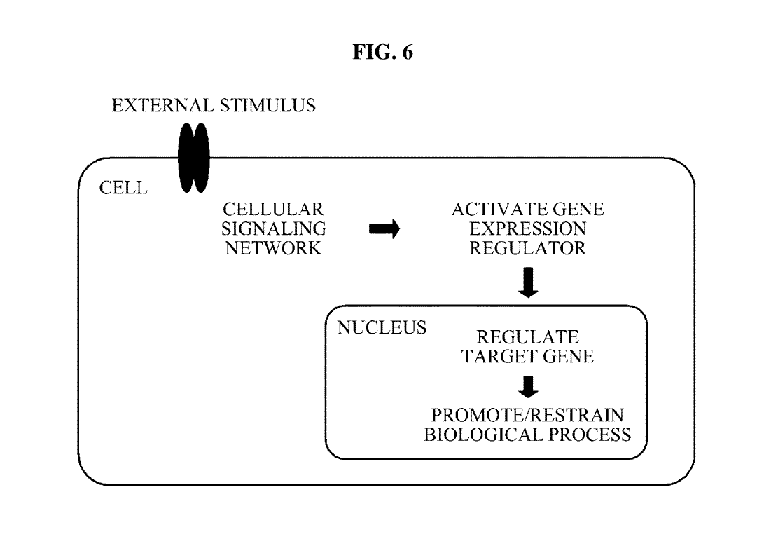

FIG. 6 is a diagram illustrating an example of an intercellular gene expression regulation mechanism.

A transcription regulator, a transcription factor, and a gene expression regulator refer to proteins or genes that are used by the body to regulate gene expression, and are used in a gene transcription process. These terms are to be understood in the same manner as a person having ordinary skill in the art would interpret the terms. For example, an extracellular signal transduction material or an external stimulus may exert an effect on a cell by the binding of the extracellular signal transduction material to a cell surface receptor that induces cellular signaling networks or signal transduction pathways. Each activated signal transduction path may activate different gene expression regulators. An activated gene expression regulator may immediately act as a transcription factor to directly regulate the expression of a target gene, or may regulate the generation of another transcription factor by regulating the expression of another target gene that codes a transcription factor. In a narrow sense, a transcription factor refers to a protein that may promote or restrain a transcription of a predetermined gene. Examples of transcription factors include, for example, nucleosome remodeling enzymes, histone metyltransferases (HMTs), histone deacetyltransferases (HDATs), histone acetyltransferases (HATs), and proteins directly related to a transcription, such as, for example, activators to be combined on a DNA, enhancers to promote a transcription of a gene, insulators to restrain a transcription of a gene, and repressors to be combined with insulators. The expression of a target gene may be regulated by such transcription factors, and proteins generated by the expression-regulated gene may carry out a single biological process within the body. While an example in which an extracellular signal transduction material binds with a cell surface receptor has been to provided herein, those skilled in the art understands that a variety of mechanism exists in nature for the regulation of gene expression.

The method of determining a transcription factor related to a biological process may further include receiving an input about a biological process of interest. A process for receiving a predetermined biological process as an input, and extracting a transcription factor related to the biological process may be quite useful for real world application. However, experimentally determining a transcription factor that is related to a predetermined biological process, among the number of transcription factors found in the human genomes, may require a considerable amount of cost and time. However, by determining in advance a desired biological process or a biological process of interest, and by comparing expression data of a gene or protein related to the predetermined biological process to expression data of a transcription factor, a transcription factor related to the desired biological process may be determined quickly and efficiently. In addition, in developing new medicine for regulating a predetermined biological process, a determination of a candidate transcription factor related to the predetermined biological process may be helpful for predicting an activity of the biological process; thus, the ability to determine a transcription factor related to a biological process may be utilized for accelerating drug development and fashioning suitable clinical trials.

The method of determining a transcription factor may include extracting gene information associated with a biological process from a first database. The first database may store gene information associated with biological processes, and output gene information corresponding to an input biological process. The first database may be a public database available to a person having ordinary skill in the art, and may include National Center for Biotechnology Information (NCBI), Swiss Institute of Bioinformatics (SIB), and European Bioinformatics Institute (EBI), but is not limited thereto. In another example, a proprietary database not available to the public may be used. In addition, sequence information of a protein or gene may be obtained through a sequence search device connected to a database. The sequence search device may include BLAST, FASTA, and Smith-Waterman algorithm, but is not limited thereto.

As described above, the gene information extracted from the first database may include all information associated with genes. In one example, the gene information from the first database may include gene information associated with a predetermined biological process, or information about proteins or genes known as being related to a predetermined biological process.

In operation 120, the method of determining a transcription factor selects M items of expression data based on similarities of the N items of expression data, and form the selected M items of expression data as a first group. Here, M may be a natural number less than or equal to N.

Expression data may refer to at least one of gene expression data and protein expression data. The gene expression data may include data obtained by measuring mRNA or cDNA in a protein synthesis process through transcription and translation. The protein expression data may include expression data of a gene that codes a protein, or data obtained by measuring a presence or an amount of a protein. The expression data may include data to be used to verify whether a gene or protein is expressed, or a level of expression, but is not limited thereto.

The expression data may be extracted from at least one second database based on the gene information, or the information about proteins or genes known as being related to a predetermined biological process. The second database may store gene information associated with expression data, and output expression data corresponding to input gene information. The second database may be a public database available to a person having ordinary skill in the art, and may include National Center for Biotechnology Information Gene Expression Omnibus (NCBI GEO), SIB, EBI, Gene Expression database of Normal and Tumor tissues (GENT), Expression Atlas, and a database possessed by a hospital or research institution, but is not limited thereto. In an example, a proprietary database may be used.

The expression data obtained from the second database may include data from other techniques used for a DNA microarray or DNA chip, a Quantitative Real-Time polymerase chain reaction (qRT-PCR), in situ hybridization, immunohistochemistry, immunofluorescence, Serial Analysis of Gene Expression (SAGE), a protein microarray, and proteomics, but is not limited thereto. As described above, the gene expression data may be data obtained by measuring an mRNA or cDNA, and the protein expression data may be expression data of a gene that codes a protein, or data obtained by measuring a presence or an amount of a protein.

The expression data may be obtained through hybridization of probes and biological samples containing at least one of DNAs having gene information and proteins expressed from the DNAs. Various techniques may be used to obtain expression data through probe hybridization. For example, a microarray may be used. When the samples containing at least one of DNAs and proteins are in contact with the probes, different levels of hybridization may be expressed depending on complementary degrees. For example, a level of hybridization may be measured using a fluorescent material. When the fluorescent material is irradiated after hybridization, a fluorescent signal emitted from the fluorescent material of the hybridized probe may be detected with a camera. The captured image may be digitally processed to detect the strength of the fluorescent signal. By receiving the fluorescent signal in a data format, expression data may be obtained.

To select the M items of expression data based on the similarities of the N items of expression data in operation 120, various statistical methods, programs, or algorithms available to a person having ordinary skill in the art may be used. In an example, a paired t-test, and an analysis of variance (ANOVA) test may be used, and a false discovery rate may be applied to correct errors when data is obtained from a microarray. The available statistical methods include GeneSpring, Cyber-T, SAM, BRB-ArrayTools, QVALUE, and FOCUS, but are not limited thereto. The M items of expression data may be selected using one or more of the various statistical methods, programs, or algorithms. An expression pattern or a level of expression from expression data may be numerically expressed and derived using the various statistical methods, programs, or algorithms, similarities of values may be calculated by statistically comparing the values, and the M items of expression data may be selected.

As described above, operation 120 may be an operation of selecting M items of similar expression data from among N items of expression data of proteins or genes related to a predetermined biological process, and forming the selected M items of expression data as a first group.

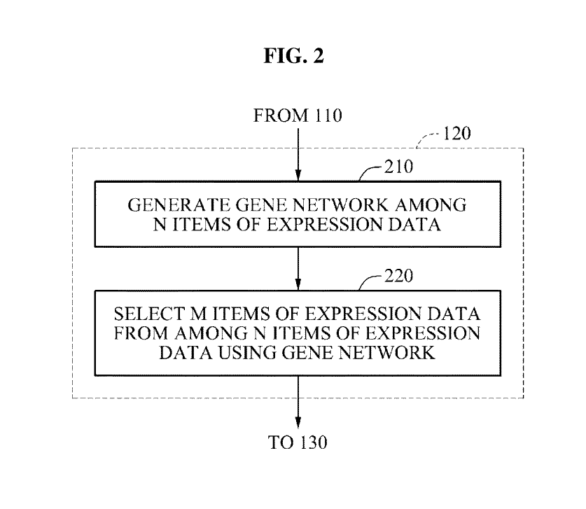

Operation 120 will be described in detail with reference to FIG. 2.

FIG. 2 is a flowchart illustrating an example of an operation of selecting M items of expression data based on similarities of N items of expression data.

Referring to FIG. 2, the operation of selecting M items of expression data based on similarities of N items of expression data includes operation 210 of generating a gene network among N items of expression data, and operation 220 of selecting M items of expression data from among the N items of expression data using the gene network.

The gene network may refer to a network expressing correlations among genes. In many cases, exhibition of a function of a gene may be performed through interactions among a number of genes, rather than a change in a single gene. Since associated genes interacting with a target gene may be expressed simultaneously, measurement of changes in expression of such genes may be difficult. Thus, by determining genes having a relatively high correlation through investigation into expression profiles of genes, and connecting two genes, a network having connectivity between the genes may be generated. The gene network may be generated using various algorithms or public programs available to a person having ordinary skill in the art.

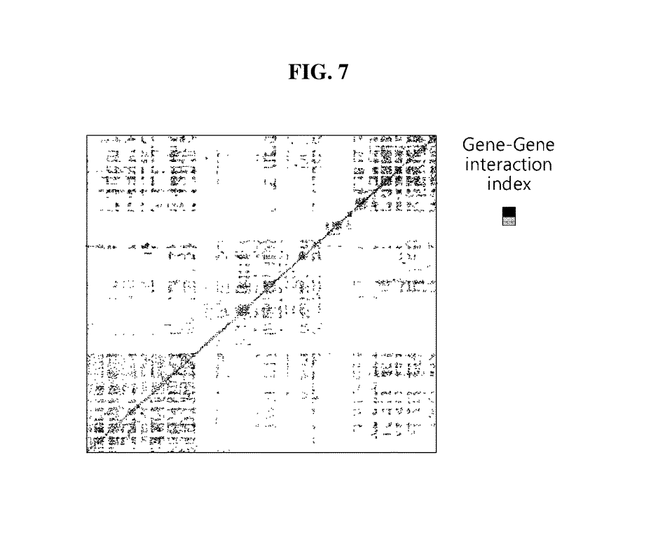

FIG. 7 illustrates an example of a diagram illustrating a gene network of genes related to a deoxyribonucleic acid (DNA) repair process. The gene network illustrated in FIG. 7 may be generated based on expression data of the genes related to the DNA repair process. In an example, the gene network may express a data value with gradation based on an index, or may express only a data value greater than or equal to a predetermined level with black color as shown in FIG. 7.

The gene network may be formed by calculating gene-gene interactions (GGIs). A method of calculating GGIs may vary depending on a program or algorithm to be used. For example, a GGI between identical genes may be set to be a reference, for example, 1.0.

In operation 220, the method of determining a transcription factor selects M items of expression data from among the N items of expression data using the gene network. As described above, the M items of expression data may be selected using the GGIs calculated from the gene network generated using the N items of expression data. For example, M items of expression data having GGIs greater than or equal to a preset threshold, for example, 0.8 may be selected in the gene network. For example, expression data corresponding to the black portions in FIG. 7 may be selected. The preset threshold may vary depending on a program or algorithm used to generate the gene network.

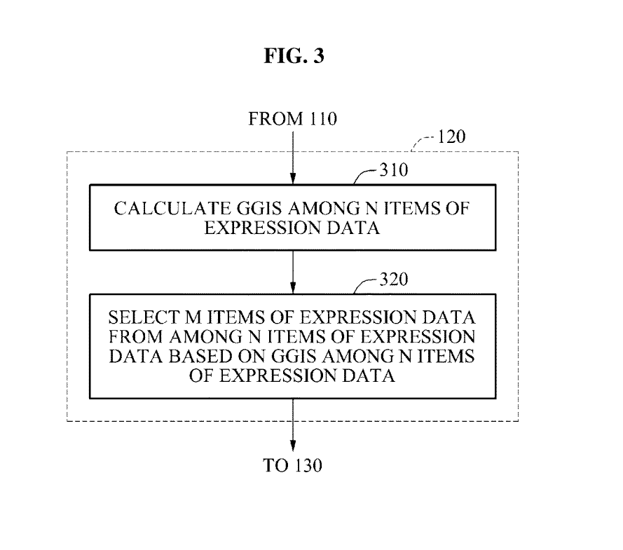

Hereinafter, another example of operation 120 will be described in detail with reference to FIG. 3

FIG. 3 is a flowchart illustrating another example of an operation of selecting M items of expression data based on similarities of N items of expression data.

Referring to FIG. 3, the operation of selecting M items of expression data based on similarities of N items of expression data includes operation 310 of calculating gene-gene interactions (GGIs) among N items of expression data, and operation 320 of selecting M items of expression data from among the N items of expression data based on the calculated GGIs among the N items of expression data.

To calculate the GGIs among the N items of expression data, various statistical methods, programs, or algorithms of analyzing respective items of expression data may be used. In an example, a paired t-test, and an ANOVA test may be used, and a false discovery rate may be applied to correct errors when data is obtained from a microarray. The available statistical methods include GeneSpring, Cyber-T, SAM, BRB-ArrayTools, QVALUE, and FOCUS, but are not limited thereto. The N items of expression data may be analyzed using the various statistical methods, programs, or algorithms, GGIs may be calculated, and the M items of expression data may be selected based on the calculated GGIs.

In operation 130, the method of determining a transcription factor for a biological process involves comparing the expression data of the first group to expression data of a plurality of transcription factors. To compare the expression data of the first group to the expression data of the plurality of transcription factors, various statistical methods, programs, or algorithms available to a person having ordinary skill in the art may be used. In an example, GeneSpring, a paired t-test, an ANOVA test, Cyber-T, SAM, BRB-ArrayTools, QVALUE, and FOCUS may be used, but the statistical methods, programs, or algorithms are not limited thereto. The expression data of the first group may be compared to the expression data of the plurality of transcription factors using the various statistical methods, programs, or algorithms.

Each level of expression of the M items of expression data or the expression data of the first group may be regulated depending on different expression conditions. That expression is regulated depending on an expression condition may be referred to as specific gene expression. Gene expression may be specifically regulated by a transcription factor. A level of expression of a transcription factor may be similar to a level of expression of a gene or protein related to the transcription factor. Thus, expression data exhibiting specific gene expression may be useful to detect a transcription factor that regulates such expression.

As described above, a transcription factor refers to a protein that may promote or restrain a transcription of a predetermined gene. More than two thousand transcription factors are known to exist in the human genome. In an example, expression data of transcription factors may be obtained from a third database. The third database may store and output expression data of transcription factors, and provide information about the transcription factors. The third database may be a public database available to a person having ordinary skill in the art, and may include NCBI GEO, SIB, EBI, Transfac, DBD, PAZAR, and a database possessed by a hospital or research institution, but is not limited thereto. For example, a proprietary database may be used, or a database may be built by combining various sources.

The expression data of the transcription factors obtained from the third database may include data from other techniques used for a DNA microarray or DNA chip, a qRT-PCR, in situ hybridization, immunohistochemistry, immunofluorescence, SAGE, a protein microarray, and proteomics, but is not limited thereto. As described above, gene expression data of a transcription factor may be data obtained by measuring an mRNA or cDNA, and protein expression data of a transcription factor may be expression data of a gene that codes a protein, or data obtained by measuring a presence or an amount of a protein.

The expression data of the transcription factors may be obtained through hybridization of probes and biological samples containing at least one of DNAs having gene information associated with the transcription factors and transcription factor proteins. Various techniques may be used to obtain expression data through probe hybridization. For example, a microarray may be used. For example, when the samples containing at least one of DNAs and proteins are in contact with the probes, different levels of hybridization may be expressed depending on complementary degrees. A level of hybridization may be measured using a fluorescent material on a microarray. When the fluorescent material is irradiated after hybridization, a fluorescent signal emitted from the fluorescent material of the hybridized probe may be detected by a camera. The image may be digitalized into a data format, and the strength of the fluorescent material may be detected from the digitalized image based of the hybridization on the microarray. By receiving the fluorescent signal in a data format, expression data may be obtained.

In operation 140, the method of determining a transcription factor for a biological process identifies at least one transcription factor having a relatively high similarity to the first group, among the transcription factors. As described above, the expression data of the first group may be compared to the expression data of the plurality of transcription factors, the similarities may be calculated, and expression data of at least one transcription factor having a relatively high similarity may be selected. The at least one transcription factor corresponding to the selected expression data may be determined to be related to a biological process. The expression data may be compared and the similarities may be calculated using the various statistical methods, programs, or algorithms described above. In addition, expression data of at least one transcription factor having a similarity greater than or equal to a preset threshold may be selected. However, in this example, the similarity may vary depending on a used method, program, or algorithm, and the preset threshold may also vary as necessary.

In an example, a DNA repair process transcription factor may be selected using the method of determining a transcription factor related to a biological process. Several transcription factors including BRCA, TP53, and USP1, known as DNA repair transcription factors, may be selected, and may be determined as transcription factors related to a DNA repair process.

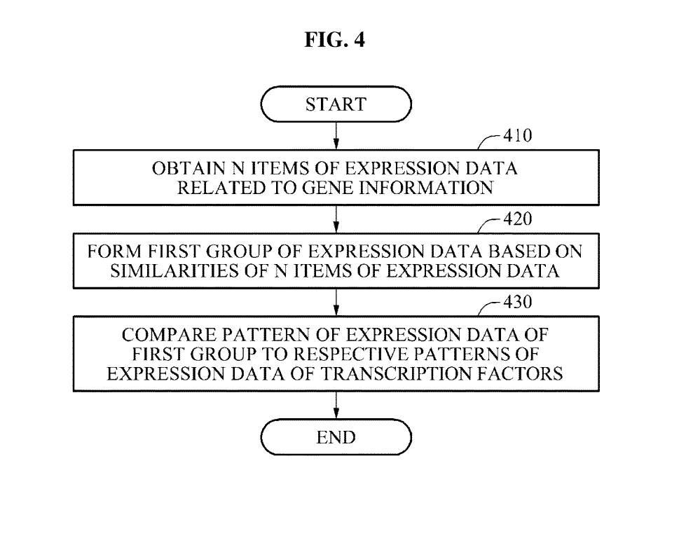

FIG. 4 is a flowchart illustrating another example of a method of determining a transcription factor for a biological process.

Referring to FIG. 4, in operation 410, the method of determining a transcription factor for a biological process involves obtaining N items of expression data related to gene information.

In operation 420, the method of determining a transcription factor involve forming a first group of expression data based on similarities of the N items of expression data. The first group may be formed using the methods described above.

In operation 430, the method of determining a transcription factor involves comparing a pattern of the expression data of the first group to respective patterns of expression data of a plurality of transcription factors. Expression data may be data exhibiting a single expression in a single expression condition, or a gene expression data set with respect to a series of expression conditions. Each level of expression of a series of expression data or an expression data set, related to each gene or protein, may be regulated based on an expression condition. The series of expression data or the expression data set may configure patterns of expression data. The expression data of the first group may be compared to the expression data of the plurality of transcription factors based on the patterns of the expression data. An interaction between a gene and a transcription factor in a biological process may be expressed as an expression pattern. Thus, comparison of expression patterns may be useful and advantageous.

In an example, the method of determining a transcription factor involved obtaining gene information associated with a DNA repair process from a first database, and the gene information contained information of 255 genes associated with the DNA repair process. The method of determining a transcription factor resulted in obtaining 204 items of gene expression data related to the 255 genes of the DNA repair process from a second database, and in obtaining expression data of transcription factors from a third database storing the expression data of the transcription factors. The method of determining a transcription factor involved extracting at least one transcription factor having a relatively high similarity by comparing similarities, for example, by calculating GGIs, between the gene expression data associated with the DNA repair process and the expression data of the transcription factors using an ANOVA test. Here, the extraction of the transcription factor may involve selecting one or a few number of transcription factors having the highest similarity. In the alternative, the extraction may involve determining transcription factors having a similarity value above a threshold value, or determining a threshold value based on the highest degree of similarity. However, the method of determining the transcription factor is not limited thereto.

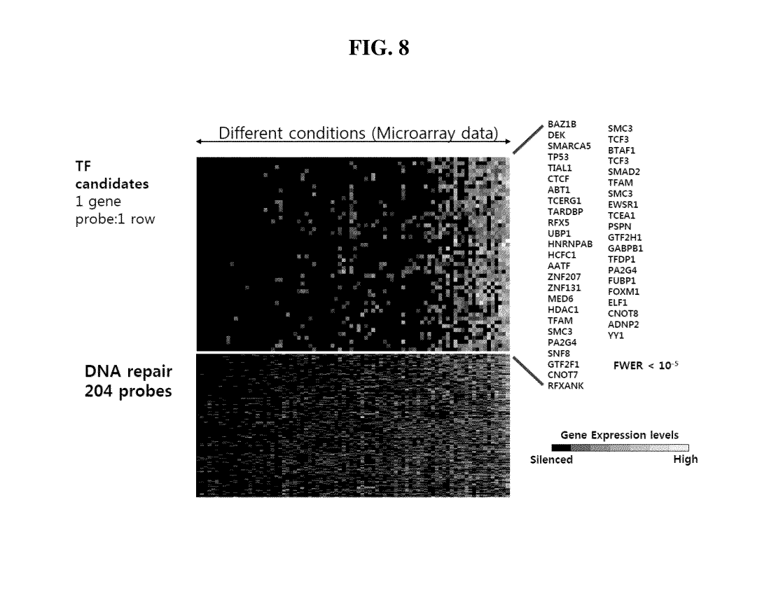

FIG. 8 illustrates examples of DNA repair gene expression data and expression data of transcription factors. The expression data found in FIG. 8 illustrates that the locations of fluorescent signals emitted from the fluorescent material of hybridized probes in a microarray can be used to determine the strength of the signal, allowing several transcription factors to be tested simultaneously. Further, the DNA repair gene expression data can be used to determine gene expression levels.

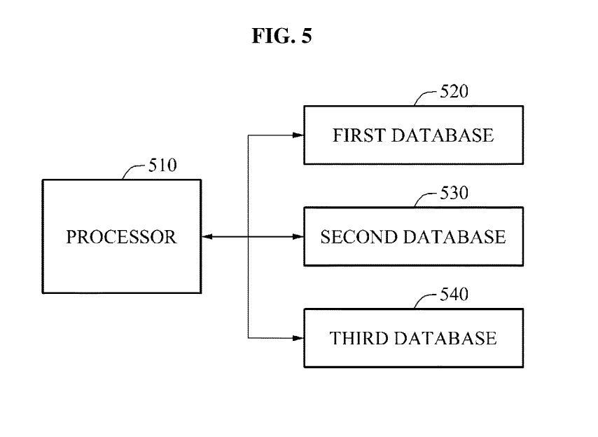

FIG. 5 is a block diagram illustrating an example of an apparatus for determining a transcription factor for a biological process from a database.

Referring to FIG. 5, a processor 510 may perform data communication with a first database 520, a second database 530, and a third database 540. The first database 520, the second database 530, and the third database 540 may each include non-transitory computer storage medium for storing gene information, expression data and the like. The processor 510 may communicate with the first database 520, the second database 530, and the third database 540 via a wired connection or a wireless connection.

The processor 510 may read out gene information associated with a biological process from the first database 520, and N items of expression data related to the gene information from the second database 530. The processor 510 may form M items of expression data selected based on similarities of the N items of expression data as a first group. The processor 510 may read out expression data of a plurality of transcription factors from the third database 540, and compare the expression data of the first group to the expression data of the plurality of transcription factors. Here, M may be a natural number less than or equal to N.

The processor 510 may select the M items of expression data from among the N items of expression data using a gene network among the N items of expression data.

The processor 510 may obtain a first pattern from the expression data of the first group, and compare the expression data of the first group to the expression data of the plurality of transcription factors by comparing the first pattern to respective patterns of expression data of the plurality of transcription factors.

The first database 520, the second database 530, and the third database 540 as described above may be the same, or may differ depending on a type of data desired to obtain. In an example, a portion of the first database 520, the second database 530, and the third database 540 may provide information associated with genes, proteins, and transcription factors, and expression data thereof, whereas another portion of the first database 520, the second database 530, and the third database 540 may provide limited data. Thus, depending on a type of data desired to obtain, the first database 520, the second database 530, and the third database 540 may be the same, or may differ. In addition, a database may or may not be included in the apparatus. When a database is provided outside the apparatus, the apparatus may receive data from the database and process the received data. By configuring a new database within the apparatus, the apparatus may store data received from the external database.

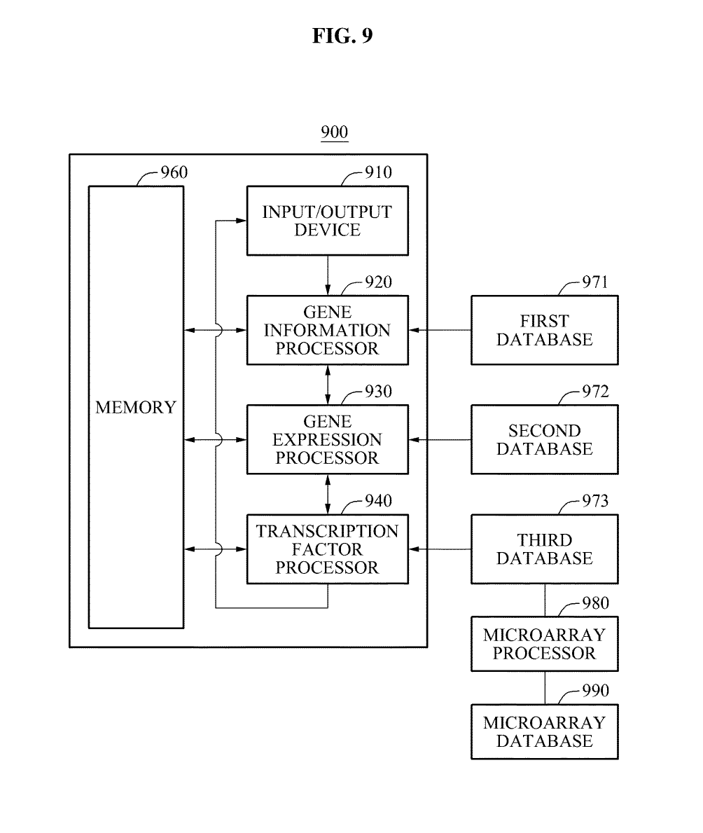

FIG. 9 is a block diagram illustrating another example of an apparatus for determining a transcription factor for a biological process.

Referring to FIG. 9, the apparatus for determining transcription factor 900 includes an input/output device 910, a gene information processor 920, a gene expression processor 930, and a transcription factor processor 940, and a memory 960. In addition, the apparatus 900 communicates with a first database 971, a second database 972, and a third database 973. While in this example the first database 971, the second database 972, and the third database 973 are located external to the apparatus 900, in another example, one or more database may be included in the apparatus 900. In addition, in this example, the third database 973 receives data from a microarray processor 980 configured to process data obtained from a microarray apparatus 990. In another example, the third database 973, the microarray processor 980, the microarray apparatus 990, or a combination thereof may be included in the apparatus for determining transcription 900.

The input/output device 910 receives an input regarding a biological process of interest, and provides an output regarding the transcription factor that may be related to the biological process of interest. For example, a biological process description regarding a biological process of interest may be input by a keyboard or a touch screen by a user, selected from a list, or a more detailed description regarding the biological process may be received as a file. The input/output device 910 may be implemented as a keyboard, a touch screen, a display, a terminal, a microphone, a speaker, or other known forms of input and output devices.

Based on the biological process description, the gene information processor 910 may obtain gene information regarding the biological process form the first database 971. Herein, the first database 971, the second database 972, and the third database 973 may each include non-transitory computer storage medium for storing gene information, expression data and the like. The apparatus 900 may communicate with the first database 971, the second database 972, and the third database 973 via a wired connection or a wireless connection.

The gene information processor 910 obtains the gene information associated with the biological process, and the expression data processor 920 obtains N items of expression data related to the gene information from the second database 972. The expression data processor 920 may form M items of expression data selected based on similarities of the N items of expression data as a first group, and store the first group in the memory 960. The transcription factor processor 930 may read out expression data of a plurality of transcription factors from the third database 973, and compare the expression data of the first group stored in the memory 960 to the expression data of the plurality of transcription factors. Here, M may be a natural number less than or equal to N.

The expression data processor 920 may select the M items of expression data from among the N items of expression data using a gene network among the N items of expression data. The gene network may be stored in a memory of the apparatus 900 or a fourth database not illustrated.

The transcription factor processor 930 may obtain a first pattern from the expression data of the first group from the memory 960, and compare the expression data of the first group to the expression data of the plurality of transcription factors by comparing the first pattern to respective patterns of expression data of the plurality of transcription factors.

The first database 971, the second database 972, and the third database 973 may be combined as one database, or may differ depending on a type of data desired to obtain. In one example, a portion of the first database 971, the second database 972, and the third database 973 may provide information associated with genes, proteins, and transcription factors, and expression data thereof, whereas another portion of the first database 971, the second database 972, and the third database 973 may provide limited data. In addition, one or more of the first database 971, the second database 972, and the third database 973 may be connected to a microarray processor 980, a data generation unit, an external database or a hospital, such that the data stored in the database may be updated. In this example, the third database 973 receives expression data of transcription factors from a microarray processor 980 that analyzes the image data obtained by a microarray apparatus 981. The microarray apparatus 981 may include a camera and a DNA microarray, DNA chip, a protein microarray and the like, to facilitate generation of relevant data. The description of examples of methods and apparatuses of determining a transcription factor described with reference to FIGS. 1-8 applies to the embodiment illustrated in FIG. 9.

The units described herein may be implemented using hardware components and software components. For example, the hardware components may include microphones, amplifiers, band-pass filters, audio to digital convertors, and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device. Examples of the non-transitory to computer readable recording medium include read-only memory (ROM), random-access memory (RAM), CD-ROMs, magnetic tapes, floppy disks, optical data storage devices. Also, functional programs, codes, and code segments that accomplish the examples disclosed herein can be easily construed by programmers skilled in the art to which the examples pertain based on and using the flow diagrams and block diagrams of the figures and their corresponding descriptions as provided herein.

The methods described herein may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes embodied herein, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of determining a transcription factor, the method comprising:
obtaining N items of expression data related to gene information;
selecting M items of expression data based on similarities of the N items of expression data, and forming the selected M items of expression data as a first group using a processor;
comparing the expression data of the first group to expression data of a plurality of transcription factors; and
identifying at least one transcription factor having a relatively high similarity to the first group, among the transcription factors,
wherein M is a natural number less than or equal to N.

2. The method of claim 1, wherein the N items of expression data related to the gene information are obtained from a second database storing expression data related to the gene information.

3. The method of claim 1, wherein the N items of expression data related to the gene information are obtained through hybridization of probes and biological samples containing at least one of deoxyribonucleic acids (DNAs) having the gene information and proteins expressed from the DNAs.

4. The method of claim 1, wherein the selecting comprises:
generating a gene network among the N items of expression data; and
selecting the M items of expression data from among the N items of expression data using the gene network.

5. The method of claim 4, wherein the selecting of the M items of expression data from among the N items of expression data using the gene network comprises:
selecting the M items of expression data having gene-gene interactions (GGIs) greater than or equal to a preset threshold in the gene network.

6. The method of claim 1, wherein the selecting comprises:
calculating GGIs among the N items of expression data; and
selecting the M items of expression data from among the N items of expression data based on the calculated GGIs among the N items of expression data.

7. The method of claim 1, wherein each level of expression of the M items of expression data is regulated depending on different expression conditions.

8. The method of claim 1, further comprising:
extracting the gene information associated with a biological process from a first database.

9. The method of claim 8, wherein the first database is configured to store the gene information associated with the biological process, and output gene information corresponding to an input biological process.

10. A method of determining a transcription factor, the method comprising:
obtaining N items of expression data related to gene information from a database comprising a memory;
forming a first group of expression data based on similarities of the N items of expression data; and
comparing a pattern of the expression data of the first group to respective patterns of expression data of a plurality of transcription factors.

11. The method of claim 10, further comprising:
identifying at least one transcription factor having a relatively high similarity to the first group, among the transcription factors.

12. The method of claim 10, wherein the forming comprises:
forming the first group of expression data by selecting M items of expression data to from among the N items of expression data using a gene network among the N items of expression data.

13. The method of claim 12, wherein the forming of the first group of expression data by selecting the M items of expression data comprises:
selecting the M items of expression data having gene-gene interactions (GGIs) greater than or equal to a preset threshold in the gene network.

14. A non-transitory computer storage medium storing instructions that cause a computer to perform the method of claim 1.

15. An apparatus for determining a transcription factor, the apparatus comprising:
a database configured to store N items of expression data related to gene information; and
a processor configured to read out the N items of expression data related to the gene information from the database, form M items of expression data selected based on similarities of the N items of expression data as a first group, and compare the expression data of the first group to expression data of a plurality of transcription factors,
wherein M is a natural number less than equal to N.

16. The apparatus of claim 15, wherein the processor is configured to select the M items of expression data from among the N items of expression data using a gene network among the N items of expression data.

17. The apparatus of claim 15, wherein the processor is configured to obtain a first pattern from the expression data of the first group, and compare the expression data of the first group to the expression data of the plurality of transcription factors by comparing the first pattern to respective patterns of the plurality of transcription factors.
